(19) United States
(12) Patent Application Publication
(10) Pub. No.: US 2026/0226859 A1
(43) Pub. Date: Aug. 6, 2026

(54) COMPRESSED GAS ENERGY STORAGE AND RECOVERY SYSTEM HAVING PRESSURE CONTROL

(71) Applicant: IFP Energies nouvelles, RUEIL-MALMAISON (FR)

(72) Inventors: Elsa MULLER-SHERNETSKY, RUEIL-MALMAISON CEDEX (FR); David TEIXEIRA, RUEIL-MALMAISON CEDEX (FR); Victor DUPIN, RUEIL-MALMAISON CEDEX (FR)

(21) Appl. No.: 19/157,496

(22) PCT Filed: Feb. 14, 2024
(86) PCT No.: PCT/EP2024/053662

§ 371 Date: Aug. 18, 2025

(30) Foreign Application Priority Data
Feb. 27, 2023 (FR) FR2301747

(51) Int. Cl. F02C 6/16

(52) U.S. Cl. CPC F02C 6/16

(57) ABSTRACT

The present invention relates to a compressed gas energy storage and recovery method and system comprising: —a gas compression line (1) having at least one compression stage (3); —at least one compressed gas storage (1000) for storing the compressed gas; and—an expansion line (2) for expanding the compressed gas stored in the compressed gas storage, the expansion line (2) comprising at least one expansion stage (4) and a means for expansion (700, 701, 702). Furthermore, the compressed gas energy storage and recovery system comprises a first means for pressure control (2000), which is positioned between the last compression stage of the compression line (1) and the compressed gas storage (1000), and preferably a second means for pressure control (2001), which is positioned between the means for compressed gas storage (1000) and the first expansion stage of the expansion line (2).

### CROSS-REFERENCE TO RELATED APPLICATIONS

Reference is made to PCT/EP2024/053662 filed Feb. 14, 2024, and French Application No. 2301747, filed Feb. 27, 2023, which are incorporated herein by reference in their entirety.

### BACKGROUND OF THE INVENTION

### Field of the Invention

The present invention relates to the storage and recovery of energy using compressed gas, notably compressed air.

### Description of the Prior Art

Whereas world energy targets seek to promote the use of renewable energy in order gradually to increase the proportion of renewables in the energy mix since the variable nature of such renewable energies remains their major disadvantage. Energy storage appears to be a highly advantageous solution for addressing this problem. By storing the surplus energy produced at peak production in order to have it available when production drops below demand, storage makes it possible to overcome the challenge of variability and provides renewable energy with flexibility, or even continuity. Thus, the need for energy storage methods and systems is likely to expand over the coming years in line with the increase in the proportion of renewable energies in the worldwide energy mix.

Numerous storage technologies currently exist with examples including mechanical storage technologies such as Pumped Energy Transfer Stations (PETS) that use hydroelectric power produced by two water reservoirs situated at different altitudes. In the electricity storage phase, water from the lower reservoir is pumped to the upper reservoir and stored at this altitude. When the demand for electricity increases, the water from the upper reservoir is returned to the lower reservoir through a hydraulic turbine which then, via an alternator, generates electricity. Hydroelectric dams also employ the same concept of the dam holding back the water at an altitude that is greater upstream than downstream, and when the demand for electricity increases, the dam releases the water through hydraulic turbine generators to produce electricity.

Electrochemical technologies may also be used for storing energy, and these include lithium-ion, lead-acid or even nickel-cadmium batteries, or else flow batteries.

Compressed Air Energy Storage, known by its abbreviation CAES, is a technique for which a first installation with a power of 290 MW was built in Germany at the end of the 1970s. The principle behind this technology is that electricity produced but not consumed is used to compress a gas, typically air. In order to avoid any damage to the compressors, the heat resulting from the compression is removed between each stage. The medium-pressure or high-pressure (40 bar to 300 bar, namely 4 to 30 MPa) compressed air is sent to a naturally-occurring storage space, such as a salt cavern, a mine (salt mine, limestone mine, coal mine) or an artificial storage space, while awaiting the energy discharge phase. During the electricity production phase, the stored air is extracted from the store so that it can be expanded through turbine generators.

A variant of the CAES technology is the adiabatic method known as AACAES (Advanced Adiabatic Compressed Air Energy Storage). The main difference compared to CAES is that the heat resulting from the compression is no longer simply removed between each stage, which is to say lost, but stored so as to be able to warm the air upstream of the turbines during the energy recovery phase. Thanks to this reuse of the thermal energy internal to the process, the efficiency of AACAES may reach around 70%, as opposed to the approximately 50% achieved with the CAES method. The cooling of the air in the compression phase may be performed in a heat exchanger using a heat transport fluid. The hot heat transport fluid will then be stored so that it can release its heat to the air at the expansion phase.

Patent application FR 3117165 A1 (WO 2022/117398) relates to an AACAES system.

FIG. 1 schematically illustrates, in a block diagram of the AACAES system and method. This figure depicts the phase of storing energy by compressing a gas, and the phase of producing energy by expanding a gas. The system according to the prior art is made up of a compression line (1), including one or more compression stages (3) depending on the air pressure to be achieved and the supplier recommendations. In the embodiment illustrated, the compression line (1) comprises three compression stages (3). Each compression stage (3) comprises a compression means (100, 101, 102) such as a compressor. The compressor (100) is a low-pressure compressor, the compressor (101) is a medium-pressure compressor, and the compressor (102) is a high-pressure compressor. The gas (10), used in the method illustrated, is ambient air, with water saturation dependent on its temperature and on its pressure. During the energy storage phase, the air is compressed in the compression line (1) then is sent to a compressed-air storage (1000) suitable for high pressures. Means for heat storage and recovery (200, 201, 202) are positioned after each compressor (100, 101, 102) of each compression stage (3) to cool the hot compressed air at the outlet of the compression stage, while storing this thermal energy. The means for heat storage and recovery (200) is suitable for the low pressure, the means for heat storage and recovery (201) is suitable for the medium pressure, and the heat storage and recovery device (202) is suitable for the high pressure. A means for cooling (300, 301, 302) may be positioned after the means for heat storage and recovery (200, 201, 202) if necessary, so as to complete the cooling of the compressed air before the next compression stage or before the air is stored. Once the air has been cooled and before the next compression stage, the condensed water derived from the moisture in the air is extracted from the air compression stream by gas-liquid separators (400, 401, 402) so that the air entering the compressor is free of any trace of liquid water. This condensing of the water may take place in the means for heat storage and recovery (200, 201, 202) and means for cooling (300, 301, 302). During the energy production phase, the compressed air is expanded through one or more turbines (700, 701, 702) or expansion stages, according to the supplier recommendations, to produce electricity via alternators which have not been depicted in the diagram. The turbine (700) is a low-pressure turbine, the turbine (701) is a medium-pressure turbine, and the turbine (702) is a high-pressure turbine.

The efficiency of each compressor (100, 101, 102) is defined for an operating point and this efficiency is maintained over a reasonably broad range about this operating point. As a result, the compression line is suitable for pressures that may vary between a minimum pressure and a maximum pressure at the outlet of the compression line with these minimum and maximum pressures being dependent on the operating range of the compressors (100, 101, 102) so that compressor efficiency is maintained throughout the compression phase.

The efficiency of each turbine (700, 701, 702) is defined for an operating point. which efficiency is maintained over a reasonably broad range about this operating point. As a result, the expansion line is suitable for pressures that may vary between a minimum pressure and a maximum pressure at the inlet of the expansion line, these minimum and maximum pressures are dependent on the operating range of the turbines (700, 701, 702) so that turbine efficiency is maintained throughout the expansion phase.

In order for the method to work, it is necessary for the variation in pressure within the means for compressed-air storage (1000) to be compatible with the pressure variations tolerated by the compressors (100, 101, 102) and the turbines (700, 701, 702). Namely that is the minimum pressure in the means for compressed-gas storage at the start of compression is at least equal to the larger value of the minimum pressure at the outlet of the compression line, and the minimum pressure at the inlet to the expansion line. Specifically, if the pressure in the means for compressed-gas storage is less than the minimum pressure at the outlet of the compression line or than that at the inlet of the expansion line, the operation of the compressors or of the turbines respectively is significantly impaired. The maximum pressure in the means for compressed-gas storage at the end of compression is less than or equal to the smaller value of the maximum pressure at the outlet of the compression line, and the maximum pressure at the inlet to the expansion line. Specifically, if the pressure in the means for compressed-gas storage is greater than the maximum pressure at the outlet of the compression line or at the inlet of the expansion line, the operation of the compressors or of the turbines respectively is significantly impaired.

Thus, the compressors and turbines dictate the efficiency of the method and their operating ranges which are set at the minimum and maximum pressures of the compressed-gas storage. Outside of this operating range, the efficiencies of the compressors and of the turbines are lower. In addition, for a defined storage capacity (namely the quantity of gas stored in the means for compressed-gas storage (1000) between the start and the end of the compression phase, or else the quantity of gas retrieved from the means for compressed-gas storage (1000) between the start and the end of the expansion phase), the variations in pressure of the means for compressed-gas storage dictate the volume of the means for compressed-gas storage, and therefore the mass and cost of the means for compressed-gas storage. It is therefore not possible to reduce the volume of the means for compressed-gas storage without adversely affecting the efficiencies of at least one of the compressors and turbines namely without making the at least one of compressors and turbines work outside of their operating range.

The Hydrostor™ system (www.hydrostor.ca) is a compressed air energy storage system. The compressed-air reservoir is kept at constant pressure by a water column. Thus, when the air of the means for compressed-gas storage is expanded, water is progressively injected into the means for compressed-gas storage in order to maintain the pressure, and when the air is compressed to fill the means for compressed-gas storage, the water present in this compressed-gas storage is progressively discharged to the surface. However, when means for compressed-gas storage is a salt cavern, it is difficult to achieve this movement of water between the compression and expansion phases, because so doing would have the effect of dissolving some of the salt of the wall of the salt cavern. Moreover, this dissolving of the salt of the reservoir may lead to problems of corrosion in the pipework.

### SUMMARY OF THE INVENTION

The invention reduces the volume of the means for compressed-gas storage while maintaining the efficiency of the means for compression and expansion of the compressed gas storage.

The invention relates to a compressed gas energy storage and recovery system comprising:
a gas compression line with at least one compression stage, each compression stage comprising a means for compression and means for a heat storage and recovery downstream, in the direction of circulation of the gas, of the means for compression,
at least one means for compressed-gas storage for storing the compressed gas,
an expansion line for expanding the compressed gas stored in the means for compressed-gas storage, the expansion line comprising at least one expansion stage, each expansion stage comprising pipes and a means for expansion, the pipes being configured to circulate the compressed gas into at least one of the means for heat storage and recovery to warm the compressed gas before it enters the means for expansion.

In addition, the compressed gas energy storage and recovery system comprises a first means for pressure-regulation positioned between the last compression stage of the compression line and the means for compressed-gas storage, and preferably a second means for pressure-regulation positioned between the means for compressed-gas storage and the first expansion stage of the expansion line.

Advantageously, the first means for pressure-regulation is configured to reduce the pressure at the outlet of the compression line to a first predetermined pressure.

The means for compressed-gas storage is situated downstream of the first means for pressure-regulation.

As a preference, the compression line is configured to achieve a pressure, at the outlet of the compression line, that is between a minimum compression pressure and a maximum compression pressure and wherein the means for first pressure-regulation is configured to reduce the pressure when the pressure of the means for compressed-gas storage is less than the minimum compression pressure.

According to a variant of the invention, the first pressure-regulator is configured to be stopped when the pressure of the means for compressed-gas storage is greater than or equal to the minimum compression pressure.

Advantageously, the second means for pressure-regulation is configured to reduce the pressure at the outlet of the means for compressed-gas storage to a second predetermined pressure before the gas enters the expansion line.

As a preference, the expansion line is configured to tolerate a pressure, at the inlet to the expansion line, that is comprised between a minimum expansion pressure and a maximum expansion pressure and wherein the second means for pressure-regulation is configured to reduce the pressure when the pressure of the means for compressed-gas storage is greater than the maximum expansion pressure.

As a preference, the second means for pressure-regulation is configured to be stopped when the pressure of the means for compressed-gas storage is less than or equal to the maximum expansion pressure.

Advantageously, at least one of the first means for and second means for pressure-regulations comprises valves, preferably pressure control valves, turbines and/or regulators.

As a preference, at least one of the means for first and second means for pressure-regulations comprises valves and surge tanks.

Advantageously, each compression stage comprises a means for cooling downstream from the means for heat storage and means for recovery and preferably a means for gas/liquid separator downstream from the means for cooling.

The invention also relates to a compressed gas energy storage and recovery method wherein use is made of a compressed gas energy storage and recovery system according to one of the preceding variants or combinations of variants, and wherein:
in a compression phase:
   use is made of the first means for pressure-regulation when the pressure at the outlet of the compression line is greater than the pressure of the means for compressed-gas storage, to reduce the pressure, preferably, to the pressure of the compressed-gas storage; * then, when the pressure of the means for compressed-gas storage reaches a first predetermined value, preferably the minimum compression pressure, the first means for regulation is stopped and compressed gas continues to be injected into the compressed-gas storage until the pressure of the means for compressed-gas storage reaches a second predetermined value, preferably the maximum compression pressure;
and preferably
in an expansion phase:
   use is made of the second means for pressure-regulation when the pressure at the outlet of the compressed-gas storage is greater than the maximum expansion pressure of the expansion line, to reduce the pressure, preferably, to the maximum expansion pressure of the expansion line;
   then, when the pressure of the means for compressed-gas storage becomes less than or equal to a first predetermined criterion, preferably the maximum expansion pressure, the second means for pressure regulation is stopped and the expansion phase continues until the pressure at the inlet to the expansion line reaches a second predetermined criterion, preferably the minimum expansion pressure.

### BRIEF DESCRIPTION OF THE DRAWINGS

Other features and advantages of at least one of the system and of the method according to the invention will become apparent on reading the following description of non-limiting exemplary embodiments with reference to the appended figures described below.

FIG. 1 (already described) depicts a compressed gas energy storage and recovery system according to the prior art;

FIG. 2 depicts a compressed gas energy storage and recovery system according to the invention; and

FIG. 3 depicts the operation of the regulator of the compressed gas energy storage and recovery system according to the invention.

### DETAILED DESCRIPTION OF THE EMBODIMENTS OF THE INVENTION

Within the meaning of the invention, the terms “upstream”, “downstream”, “before” and “after” are to be understood as meaning in the direction in which gas flows in the system or the method.

The invention relates to a compressed gas energy storage and recovery system (notably using air, and more particularly air taken from the ambient surroundings), comprising:
a gas compression line with at least one compression stage, each compression stage comprising a means for compression, such as a compressor, and a means for heat storage and a means for recovery downstream, in the direction of circulation of the gas, of the means for compression;
at least one means for compressed-gas storage (notably a reservoir or a cavity) for storing the compressed gas; and
an expansion line for expanding the compressed gas stored in the means for compressed-gas storage, the expansion line comprising at least one expansion stage, each expansion stage comprising pipes and a means for expansion (for example a turbine), the pipes being configured to circulate the compressed gas into at least one of the means for heat storage and means for recovery to warm the compressed gas before the means for expansion.

Thus, the compression line makes it possible to compress gas, where an electricity production exceeds demand so that it is possible for the compressed gas to be used subsequently to supply electricity when the demand for electricity is high. The compression line therefore makes it possible to store energy as compressed gas (notably compressed air, the air advantageously being taken from the ambient surroundings).

The expansion line enables the stored compressed gas to be converted into mechanical energy, for example rotational energy, via the means for expansion (for example a turbine) of each expansion stage. Advantageously, the means for expansion may be coupled to a generator (also referred to as an alternator) to convert the mechanical energy into electricity.

In both the compression line and the expansion line the various stages (respectively compression or expansion stages) are successive, which is to say are positioned in series one after another in the direction of circulation of the gas in the compression or expansion line respectively.

The name of “first” compression or expansion stage is given to the first stage in the line concerned to have the gas pass through it in the direction in which the compressed gas circulates through the system.

The name of “last” compression or expansion stage is given to the last stage in the line concerned to have the gas pass through it in the direction in which the compressed gas circulates through the system.

Each means for heat storage and means for recovery is able to recover thermal energy in addition to the energy of the compressed gas, thereby making it possible to improve the efficiency of the system as the thermal energy is recovered during the expansion phase.

The means for heat storage and means for recovery may be direct or indirect heat storage and recoverystages.

What is meant by a “means for direct heat storage and recovery” is that this means for heat storage and recovery allows a direct exchange of heat between the compressed gas (the heat of which is to be recovered during the compression phase and which is to be warmed in the expansion phase) and a heat-storage material (which may be liquid, gaseous or solid, such as beads or chippings in particular). In other words, this may be a direct heat exchanger for exchanges between the compressed gas and a heat storage and recovery material, such as a reservoir containing beads or chippings of a heat-storage material.

What is meant by a “means for indirect heat storage and recovery” is that this means for heat storage and recovery allows an indirect exchange of heat between the compressed gas (the heat of which is to be recovered during the compression phase and which is to be warmed in the expansion phase) and a heat-storage material (advantageously a liquid or gaseous fluid). The heat-storage material is separated from the compressed gas by a wall that thus prevents direct exchange of heat between these two elements, hence the designation “indirect exchange”. In other words, this may be an indirect heat exchanger such as a tube or plate heat exchanger for enabling an exchange of heat between the compressed gas and a heat storage and recovery fluid.

The means for compressed-gas storage may be an artificial reservoir or, more advantageously, an underground cavity such as a salt cavern, a mine or an aquifer which are not used.

Advantageously, the first means for pressure regulation may separate the compression line from the means for compressed-gas storage, and preferably the means for second pressure-regulation (when the system comprises such a second means for pressure-regulation) may separate the means for compressed-gas storage from the expansion line. In other words, the compression line stops at the first means for pressure-regulation and the expansion line starts at the second means for pressure-regulation.

According to the invention, the compressed gas energy storage and recovery system comprises a first means for pressure-regulation positioned between the last compression stage of the compression line and the means for compressed-gas storage and preferably a second means for pressure-regulation positioned between the means for compressed-gas storage and the first expansion stage of the expansion line. Specifically, the pressure in the means for compressed-gas storage can thus be regulated in such a way as to increase the variation in pressure of the means for compressed-gas storage at the same time ensuring a pressure range that is acceptable to at least one of the means for compression and expansion line.

Specifically, when the pressure of the means for compressed-gas storage is less than the minimum pressure for the compression line, the means for pressure-regulation makes it possible to ensure the minimum pressure in the compression line. Likewise, when the pressure of the means for compressed-gas storage is greater than the maximum pressure for the expansion line, the means for pressure-regulation makes it possible to ensure the maximum pressure in the expansion line. In addition, the means for compressed-gas storage is thus able to tolerate a greater pressure variation (compared with the system without the means for pressure-regulation). It is therefore possible to reduce the volume of the compressed-gas storage or to store/recover more compressed gas using a means for compressed-gas storage of the same volume. System performance is thus increased.

For example, the system may comprise a first means for pressure-regulation situated just upstream from the means for compressed-gas storage (which is to say directly upstream, or in other words that there is no equipment other than possibly a pipe between at least one of the first means for pressure-regulation and the at least one of the means for compressed-gas storage) and the system may comprise a second means for pressure-regulation situated just downstream of the means for compressed-gas storage (which is to say directly downstream, or in other words that there is no equipment other than possibly a pipe between the means for compressed-gas storage and the second means for pressure-regulation).

As a preference, the compressed gas energy storage and recovery system may comprise a first means for pressure-regulation positioned between the last compression stage of the compression line and the means for compressed-gas storage, and a second means for pressure-regulation positioned between the means for compressed-gas storage and the first expansion stage of the expansion line. By using a means for pressure regulation on each side of the means for compressed gas storage, it is possible simultaneously to increase the quantity of gas stored and recovered and therefore to improve at least one of performance and to reduce still further the volume of the means for compressed-gas storage. Specifically, and surprisingly, although the overall efficiency is reduced through the use of the means for pressure-regulations, the overall performance of the system is improved, notably through the reduction of the volume of the means for compressed-gas storage.

Advantageously, the first means for pressure-regulations may be configured to reduce the pressure at the outlet of the compression line to a first predetermined pressure. In this way it is possible to guarantee the minimum pressure of the compression line for correct operation of the means for compression (such as compressors) and allow a lower pressure in the means for compressed-gas storage (which means that the gas can then be expanded to a lower pressure during the expansion phase thereby enabling a greater quantity of gas to be recovered).

Advantageously, the compression line may be configured to achieve a pressure, at the outlet of the compression line, that is comprised between a minimum compression pressure and a maximum compression pressure, to ensure that the means for compression (notably compressors) are operating inside their operating ranges. The minimum and maximum compression pressures then correspond to the pressures at the outlet of the compression line corresponding to these operating ranges. Furthermore, the first means for pressure-regulation may be configured to reduce the pressure when the (instantaneous) pressure of the means for compressed-gas storage is less than the minimum compression pressure. In this way, in order to ensure correct operation and avoid damage, the means for compression do not work with an outlet pressure that is less than this minimum compression pressure.

As a preference, the first means for pressure-regulation may be configured to be stopped when the pressure of the compressed-gas storage is greater than or equal to the minimum compression pressure. Specifically, when the pressure of the means for compressed-gas storage reaches at least the minimum compression pressure, the compression line may then work in its normal operating range. By thus stopping the pressure regulation, energy losses associated with this regulation can be limited, thereby optimizing the overall efficiency of the system.

Additionally or alternatively, the second means for pressure-regulation may be configured to reduce the pressure at the outlet of the means for compressed-gas storage to a second predetermined pressure before the gas enters the expansion line. In this way it is possible to guarantee the maximum pressure of the expansion line for correct operation of the means for expansion (such as turbines) and allow a higher pressure in the means for compressed-gas storage (which means that the pressure obtained at the end of the compression phase can be increased, thereby increasing the quantity of gas that can be stored in the means for compressed-gas storage).

Advantageously, the expansion line may be configured to tolerate a pressure, at the inlet of the expansion line, that is comprised between a minimum expansion pressure and a maximum expansion pressure, to ensure that the means for expansion (notably turbines) are operating inside their operating ranges. The minimum and maximum expansion pressures then correspond to the pressures at the inlet of the expansion line corresponding to these operating ranges. Furthermore, the second means for pressure-regulation may be configured to reduce the pressure when the pressure of the means for compressed-gas storage device is greater than the maximum expansion pressure. In this way, in order to ensure correct operation and avoid damage, the means for expansion does not work with an outlet pressure that is greater than this maximum pressure.

As a preference, the second means for pressure-regulation may be configured to be stopped when the pressure of the means for compressed-gas storage is less than or equal to the maximum expansion pressure. Specifically, when the pressure of the means for compressed-gas storage is below the maximum expansion pressure, the expansion line may then work in its normal operating range. By thus stopping the pressure regulation, energy losses associated with this regulation can be limited, thereby optimizing the overall efficiency of the system.

According to a variant of the invention, the at least one of the first and second means for pressure-regulations may comprise valves, preferably pressure control valves, and at least one of turbines and regulators. These components enable precise and controlled pressure regulation. They may be active components (namely components operated by a control, for example a computer or a processor) or passive components (that open and close according to the pressure, without the need for driven control).

Advantageously, the at least one of first and second means for pressure-regulations may comprise valves and surge tanks, namely a tank that is smaller in size than the compressed-gas storage. By using surge tanks, the pressure can be regulated more precisely and water hammer in the pipework can be avoided.

As a preference, each compression stage may comprise a means for cooling downstream (in the direction in which the compressed gas circulates) of the means for heat storage and recovery to cool the gas as much as possible before it enters the next compression stage. Furthermore, each compression stage may comprise a means for gas/liquid separation downstream (in the direction in which the compressed gas circulates) of the means for cooling.

Specifically, as the compressed gas is cooled, condensation may appear. This water, in liquid form, may be derived from the water vapor initially contained in the gas drawn in, notably when this gas is ambient air, and may damage the compression phase of the next stage, notably when this is a compressor. The gas/liquid means for separation then makes it possible to eliminate the liquid phase contained in the compressed gas.

The invention also relates to a compressed gas energy storage and recovery method wherein use is made of a compressed gas energy storage and recovery system according to any one of the variants or combinations of variants described hereinabove. The method may notably comprise a compression step, a step of storing the compressed gas, and an expansion step. In addition, in this method, at least the following steps are performed:
in a compression phase:
   use is made of the first means for pressure-regulation when the pressure at the outlet of the compression line is greater than the (instantaneous) pressure of the means for compressed-gas storage, to reduce the pressure, preferably, to the pressure of the means for compressed-gas storage. In this way, the means for compressed-gas storage can be made to work at a pressure that is less than the minimum compression pressure, notably by expanding the compressed gas to such a value.
   then, when the pressure of the means for compressed-gas storage reaches a first predetermined value, preferably the minimum compression pressure, pressure regulation using the first means for regulation is stopped and compressed gas continues to be injected into the means for compressed-gas storage until the pressure of the means for compressed-gas storage reaches a second predetermined value, preferably the maximum compression pressure. Thus, the maximum pressure of the means for compressed-gas storage is equal to the maximum compression pressure of the compression line.

Further, as a preference:
in an expansion phase:
   use is made of the second means for pressure-regulation when the pressure at the outlet of the means for compressed-gas storage is greater than the maximum expansion pressure of the expansion line, to reduce the pressure, preferably, to the maximum expansion pressure of the expansion line. In this way, the means for compressed-gas storage can be made to work at a pressure that is greater than the maximum expansion pressure.
   then, when the pressure of the means for compressed-gas storage becomes less than or equal to a first predetermined criterion, preferably the maximum expansion pressure, pressure regulation using the second means for pressure regulation is stopped and the expansion phase continues until the pressure at the inlet to the expansion line reaches a second predetermined criterion, preferably the minimum expansion pressure. Thus, the minimum pressure of the means for compressed-gas storage is equal to the minimum expansion pressure of the expansion line.

Advantageously, the first means for pressure regulation may separate the compression line from the means for compressed-gas storage, and preferably the second means for pressure-regulation (when the system comprises such a second means for pressure-regulation) may separate the compressed-gas storage from the expansion line. In other words, the compression line stops at the first means for pressure-regulation and the expansion line starts at the second means for pressure-regulation.

As a preference, the compression line, upstream of the first pressure-regulator, is configured to achieve a pressure, at the outlet of the compression line, that is comprised between a minimum compression pressure and a maximum compression pressure and the pressure of the compression line, downstream of the first means for pressure-regulation, can be reduced, when the pressure of the means for compressed-gas storage is less than the minimum compression pressure, as a result of the first means for pressure-regulation.

As a preference, the expansion line may be configured to tolerate a pressure, at the inlet to the expansion line and downstream of the second means for pressure-regulation, that is comprised between a minimum expansion pressure and a maximum expansion pressure and the pressure can be reduced using the second means for pressure-regulation when the gas pressure of the means for compressed-gas storage is greater than the maximum expansion pressure.

According to one configuration of the invention, the second means for pressure-regulation can be stopped (and then behaves like a pipe) when the pressure of the means for compressed-gas storage is less than or equal to the maximum expansion pressure.

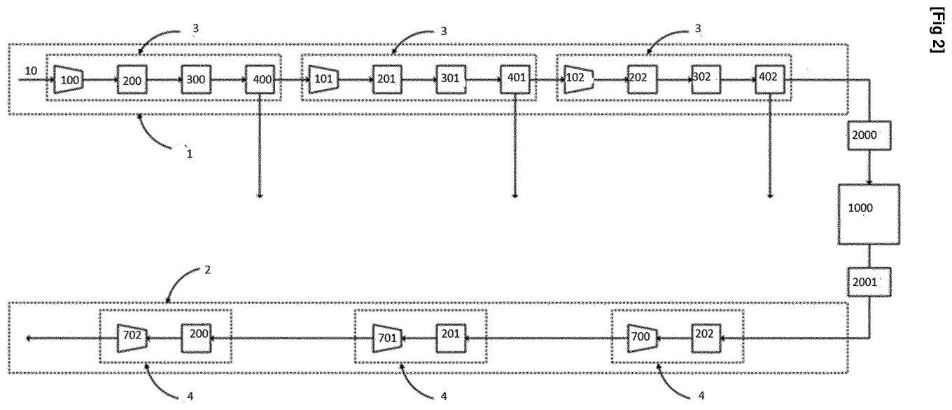

FIG. 2 illustrates, schematically and without limitation, a compressed gas energy storage and recovery system according to one embodiment of the invention.

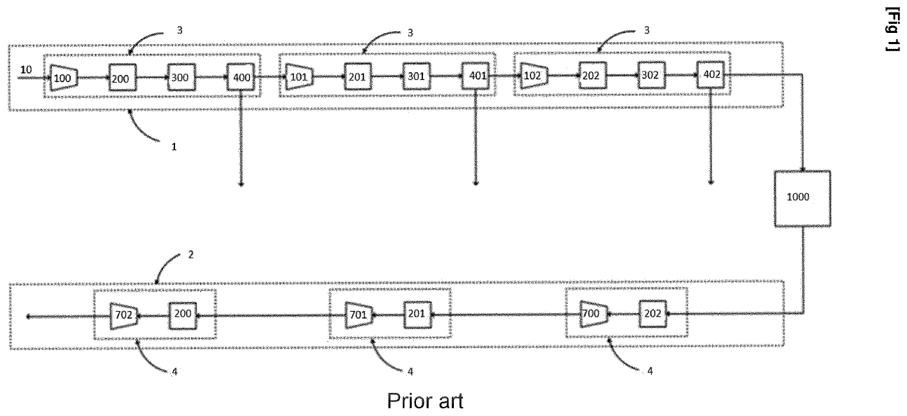

References identical to those in FIG. 1 correspond to the same elements and will not be detailed again. FIG. 2 illustrates a compression line with three compression stages and an expansion line with three expansion stages. However, the invention is suitable for other configurations, in other words configurations with other numbers of compression stages and of expansion stages. In addition, the number of expansion stages may be different than the number of compression stages.

FIG. 2 differs from FIG. 1 by the addition of a first means for pressure-regulation (2000) and of a second means for pressure-regulation (2001). The first means for pressure-regulation (2000) is situated after the compression line, between the last compression stage and the means for compressed-gas storage (1000). In other words, it is positioned just upstream of the means for compressed-gas storage (1000).

The second means for pressure-regulation (2001) is situated before the expansion line, between the means for compressed-gas storage (1000) and the first expansion stage. In other words, it is positioned just downstream of the means for compressed-gas storage (1000).

The first and second means for pressure-regulations (2000) and (2001) each advantageously comprise a pressure-control valve, preferably each one associated with a surge tank (not depicted), with a tank of smaller size (smaller volume) than the means for compressed-gas storage.

The means for compression (100, 101, 102) may be compressors, for example axial or centrifugal compressors.

The means for expansion (700, 701, 702) may be turbines, advantageously each coupled to a generator to generate electrical energy.

The means for compressed-gas storage (1000) may be a natural cavity, such as a salt cavern, amine, an aquifer which is not being used, or else an artificial reservoir.

It is possible for the system of the invention not to have means for cooling (300, 301, 302) or for it to comprise only some of these.

It is possible for the system of the invention not to comprise means for gas/liquid separation (400, 401, 402) or to comprise only some of these.

In other words, the means for cooling (300, 301, 302) and the means for gas/liquid separation (400, 401, 402) are optional.

Each means for compressor (100, 101, 102) is configured to operate in an operating range that is defined in such a way as to maximize its efficiency. This operating range corresponds to the minimum and maximum pressures acceptable at the outlet of each compression stage, thus defining the minimum and maximum compression pressures at the outlet of the last compression stage.

Each means for expansion (700, 701, 702) is configured to operate in an operating range that is defined in such a way as to maximize its efficiency. This operating range corresponds to the minimum and maximum pressures acceptable at the inlet of each expansion stage, thus defining the minimum and maximum expansion pressures at the inlet of the first expansion stage.

The means for compressed-gas storage (1000) defines the energy storage capacity of the method and of the system, notably by way of its volume and pressure-variation pair. The storage capacity is defined as the quantity of gas stored in the means for compressed-gas storage (1000) between the start and the end of the compression phase, or else by the quantity of gas recovered from the means for compressed-gas storage (1000) between the start and the end of the expansion phase. The difference in pressure (or variation in pressure) of the means for compressed-gas storage (1000) between the start and the end of each phase, whether it is compression or expansion, and also referred to as the “breathability of the cavity”, imposes, for a defined storage capacity, a fixed means for compressed-gas storage volume. For the same storage capacity, the lower the breathability of the cavity, the higher the volume of the compressed-gas storage needs to be. Conversely, the higher the breathability of the cavity, the lower the volume of the compressed-gas storage can be.

In the context of the compressed gas energy storage and recovery method and system, there are therefore three parameters that are interlinked:
the compressed gas energy storage capacity;
the volume of the compressed-gas storage (1000); and
the efficiency of the method.

In addition, the energy storage capacity and the volume of the means for compressed-gas storage (1000) are linked by the breathability of the cavity.

The efficiency of the method is dependent on the efficiencies of the means for compression and expansion, and therefore on their operating range, as explained hereinabove.

Adding the first and second means for pressure-regulations (2000) and (2001) on each side of the means for compressed-gas storages (1000) enables flexibility in the sizing of the overall method and of the means for compressed-gas storage (1000) and therefore enables overall optimization thereof.

The use of the first and second means for pressure-regulationg (2000, 2001) makes it possible to optimize the volume of the means for compressed-gas storage (1000) for a set storage capacity. Advantageously, the minimum pressure of the means for compressed-gas storage (1000) may be equal to the minimum expansion pressure, and the maximum pressure of the means for compressed-gas storage (1000) may be equal to the maximum compression pressure.

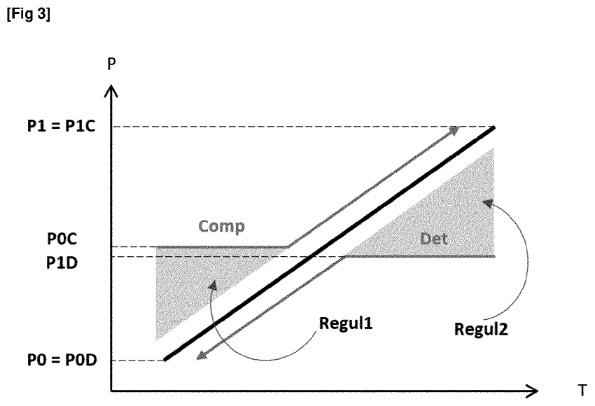

FIG. 3 illustrates, schematically and non-limitingly, the operation of the means for regulation pressure of the compressed gas energy storage and recovery system according to the invention.

The diagram illustrates the variation in pressure P over the course of time T.

The pale gray curves Comp and Det correspond, respectively, to the pressures at the output of the last compression stage and at the input of the first expansion stage, and the black curve represents the variation in pressure within the means for compressed-gas storage as a result of the first and second means for pressure-regulation.

The compression curve Comp is read in the same direction as the variation in time T, while the curve Det is read in the opposite direction to time T.

The pressure regulation may be performed in two phases, depending on the number and location of the means for pressure regulation, at the start of compression and at the start of expansion.

During compression (Comp), the first regulation (Regul1) may be performed as follows:
At the start of compression (Comp), the minimum compression pressure POC is greater than the minimum pressure of the compressed-gas storage P0; the first means for pressure-regulation expands the compressed gas leaving the last compression stage before it enters the compressed-gas storage in order to suit it to and reach the (instantaneous) pressure of the compressed-gas storage;
Progressively, the pressure in the means for compressed-gas storages increases and so long as this instantaneous pressure remains less than the minimum compression pressure POC, the first means for pressure-regulation continues to expand the compressed gas entering the means for compressed-gas storage in order to suit it to and reach the pressure in the compressed-gas storage at each instant T;
The pressure in the means for compressed-gas storage ultimately reaches the minimum compression pressure POC, so the first means for pressure-regulation stops: this is the end of the regulation zone;
The pressure reached at the outlet of the compression line progressively increases while at the same time the pressure of the means for compressed-gas storage increases until the maximum compression pressure PIC is reached, which then corresponds to the maximum pressure of the means for compressed-gas storage P1: this is the end of the compression phase.

During expansion (Det), the second regulation (Regul2) may be performed as follows:
At the start of expansion (Det), the maximum pressure of the means for compressed-gas storage P1 is greater than the maximum expansion pressure PID, and the second means for pressure-regulation expands the compressed gas leaving the means for compressed-gas storage before it enters the first expansion stage to match it to and reach the (instantaneous) pressure at the inlet to the first expansion stage;
Progressively, the pressure in the means for compressed-gas storage decreases and so long as this instantaneous pressure remains greater than the maximum expansion pressure PID, the second means for pressure-regulation continues to expand the compressed gas leaving the means for compressed-gas storage in order to match it to and reach the maximum expansion pressure PID at the inlet to the first expansion stage at each instant T;
The pressure in the means for compressed-gas storage ultimately reaches the maximum expansion pressure PID, so the second means for pressure-regulation stops which is the end of the regulation zone;
The pressure of the compressed gas coming from the means for compressed-gas storage decreases progressively as this storage empties, until the minimum expansion pressure POD is reached, which then corresponds to the minimum pressure of the compressed-gas storage: this is the end of the expansion phase.

### EXAMPLES

A system in accordance with the invention, according to FIG. 2, was compared against a system of the prior art according to FIG. 1.

Table 1 illustrates the system of the prior art and table 2 illustrates the system according to the invention.

TABLE 1
(according to the prior art):

| Storage capacity | 1 | GWh |
|---|---|---|
| Cavity breathability | 10 bar | (=1 MPa) |
| Maximum pressure of the means for | 120 bar | (12 MPa) |
| compressed-gas storage | | |
| Volume of the means for compressed- | 1 000 000 | m3 |
| gas storage | | |
| Pressure variation tolerated at the outlet | 10 bar | (=1 MPa) |
| of the compression line | | |
| Maximum pressure at the outlet of the | 120 bar | (12 MPa) |
| compression line | | |
| Pressure variation tolerated at the inlet | 10 bar | (=1 MPa) |
| of the expansion line | | |
| Maximum pressure at the inlet of the | 120 bar | (12 MPa) |
| expansion line | | |
| Efficiency of storage system and | 70% | |
| method | | |

TABLE 2
(according to the invention):

| Storage capacity | 1 | GWh |
|---|---|---|
| Cavity breathability | 20 bar | (=2 MPa) |
| Maximum pressure of the means for | 120 bar | (12 MPa) |
| compressed-gas storage | | |
| Volume of the means for compressed- | 500 000 | m3 |
| gas storage | | |
| Pressure variation tolerated at the outlet | 10 bar | (=1 MPa) |
| of the compression line | | |
| Maximum pressure at the outlet of the | 120 bar | (12 MPa) |
| compression line | | |
| Pressure variation tolerated at the inlet | 10 bar | (=1 MPa) |
| of the expansion line | | |
| Maximum pressure at the inlet of the | 110 bar | (11 MPa) |
| expansion line | | |
| Efficiency of storage system and | 68% | |
| method | | |

Comparison of tables 1 and 2 reveals that the system of the invention, with the means for pressure-regulation, allows efficiency/sizing optimization while reducing the volume of the means for compressed-gas storage by 50% with a loss of just 2% in efficiency for the same storage capacity.

1. A compressed gas energy storage and recovery system comprising:
a gas compression line (1) with at least one compression stage (3), each compression stage (3) comprising a compression means (100, 101, 102) and a heat storage and recovery means (200, 201, 202) downstream, in the direction of circulation of the gas, of said compression means (100, 101, 102),
at least one compressed-gas storage means (1000) for storing the compressed gas,
an expansion line (2) for expanding the compressed gas stored in the compressed-gas storage means (1000), the expansion line (2) comprising at least one expansion stage (4), each expansion stage (4) comprising pipes and an expansion means (700, 701, 702), the pipes being configured to circulate the compressed gas into at least one of the heat storage and recovery means (200, 201, 202) so as to warm the compressed gas before the expansion means (700, 701, 702), characterized in that the compressed gas energy storage and recovery system comprises a first pressure-regulating means (2000) positioned between the last compression stage of the compression line and the compressed-gas storage means (1000), and preferably a second pressure-regulating means (2001) positioned between the compressed-gas storage means (1000) and the first expansion stage of the expansion line.

2. The compressed gas energy storage and recovery system as claimed in claim 1, wherein the first pressure-regulating means (2000) is configured to reduce the pressure at the outlet of the compression line to a first predetermined pressure.

3. The compressed gas energy storage and recovery system as claimed in claim 2, wherein the compression line (1) is configured to achieve a pressure, at the outlet of the compression line, that is comprised between a minimum compression pressure and a maximum compression pressure and wherein the first pressure-regulating means (2000) is configured to reduce the pressure when the pressure of the compressed-gas storage means is less than the minimum compression pressure.

4. The compressed gas energy storage and recovery system as claimed in claim 3, wherein the first pressure-regulating means (2000) is configured to be stopped when the pressure of the compressed-gas storage means (1000) is greater than or equal to the minimum compression pressure.

5. The compressed gas energy storage and recovery system as claimed in claim 1, wherein the second pressure-regulating means (2001) is configured to reduce the pressure at the outlet of the compressed-gas storage means (1000) to a second predetermined pressure before the gas enters the expansion line (2).

6. The compressed gas energy storage and recovery system as claimed in claim 5, wherein the expansion line (2) is configured to tolerate a pressure, at the inlet to the expansion line, that is comprised between a minimum expansion pressure and a maximum expansion pressure and wherein the second pressure-regulating means (2001) is configured to reduce the pressure when the pressure of the compressed-gas storage means (1000) is greater than the maximum expansion pressure.

7. The compressed gas energy storage and recovery system as claimed in claim 6, wherein the second pressure-regulating means (2001) is configured to be stopped when the pressure of the compressed-gas storage means (1000) is less than or equal to the maximum expansion pressure.

8. The compressed gas energy storage and recovery system as claimed in claim 1, wherein said first and/or second pressure-regulating means (2000, 2001) comprise valves, preferably pressure control valves, turbines and/or regulators.

9. The compressed gas energy storage and recovery system as claimed in claim 8, wherein said first and/or second pressure-regulating means (2000, 2001) comprise valves and surge tanks.

10. The compressed gas energy storage and recovery system as claimed in claim 1, wherein each compression stage (3) comprises a cooling means (300, 301, 302) downstream of the heat storage and recovery means (200, 201, 202) and preferably a gas/liquid separation means (400, 401, 402) downstream of the cooling means (300, 301, 302).

11. A compressed gas energy storage and recovery method wherein use is made of a compressed gas energy storage and recovery system as claimed in claim 1, and wherein:
in a compression phase:
use is made of the first pressure-regulating means (2000) when the pressure at the outlet of the compression line (1) is greater than the pressure of the compressed-gas storage means (1000), so as to reduce the pressure, preferably, to the pressure of the compressed-gas storage means (1000);
then, when the pressure of the compressed-gas storage means (1000) reaches a first predetermined value, preferably the minimum compression pressure, the first regulating means (2000) is stopped and compressed gas continues to be injected into the compressed-gas storage means (1000) until the pressure of the compressed-gas storage means (1000) reaches a second predetermined value, preferably the maximum compression pressure;
and preferably
in an expansion phase:
use is made of the second pressure-regulating means (2001) when the pressure at the outlet of the compressed-gas storage means (1000) is greater than the maximum expansion pressure of the expansion line, so as to reduce the pressure, preferably, to the maximum expansion pressure of the expansion line (2);
then, when the pressure of the compressed-gas storage means (1000) becomes less than or equal to a first predetermined criterion, preferably the maximum expansion pressure, the second regulating means (2001) is stopped and the expansion phase continues until the pressure at the inlet to the expansion line (2) reaches a second predetermined criterion, preferably the minimum expansion pressure.
